(19) United States
(12) Patent Application Publication
(10) Pub. No.: US 2026/0044757 A1
(43) Pub. Date: Feb. 12, 2026

(54) CONTENT MANAGEMENT AND DELIVERY FOR A COMMUNICATION CHANNEL

(71) Applicant: SUBFLOW, INC., Franklin, TN (US)

(72) Inventors: Mitchell Lawson, Franklin, TN (US); William Golden, Nashville, TN (US)

(73) Assignee: SUBFLOW, INC., Franklin, TN (US)

(21) Appl. No.: 19/365,589

(22) Filed: Oct. 22, 2025

Related U.S. Application Data
(63) Continuation-in-part of application No. 18/236,292, filed on Aug. 21, 2023.

(51) Int. Cl. G06N 5/04

(52) U.S. Cl. CPC G06N 5/04

(57) ABSTRACT

A method for managing and delivering content associated with a communication channel is disclosed. The method may comprise generating a summary of interaction data between a patient and a provider using a large language model (LLM). The method may provide the interaction data as input to a second machine-learning (ML) model to help generate a risk score of the interaction data. The method may receive, by an agentic tool, a prompt associated with the interaction data and, in response to receiving the prompt, generating an answer within a closed data space of the interaction data, the summary, and the risk score. The method may also generate and send, by a workflow process, an alert to one or more entities associated with the patient or determine at least one next clinical step to suggest to the provider or patient that enables proactive outreach to the patient.

### CROSS REFERENCE TO RELATED APPLICATIONS

The present application is a continuation-in-part of U.S. patent application Ser. No. 18/236,292, filed Aug. 21, 2023, which is incorporated by reference in its entirety.

### TECHNICAL FIELD

This disclosure relates to content delivery services and, more particularly, to managing and delivering content to subscribers to a communication channel.

### BACKGROUND

Businesses, schools, individual content creators, and the like, manage distribution of content and communication with subscribers using a variety of tools and platforms. In some cases, content may be created and uploaded to a web-service provider, which a subscriber can access via internet browser software. Communication with subscribers may be performed using a separate electronic mail (“e-mail”) server.

### SUMMARY

Various embodiments of a method for managing and delivering content via a communication channel are disclosed. Broadly speaking, a method may include uploading, to a server, a plurality of pieces of content that are associated with a communication. The method also includes sending a plurality of messages to corresponding ones of a plurality of subscribers to the communication channel. The plurality of messages may include a link to a given piece of content of the plurality of pieces of content. Additionally, the method includes monitoring access to a particular piece of content and, in response to determining the particular piece of content has been accessed, sending a follow-up message to a particular subscriber.

In some embodiments, interactions with content on the server may be identified and analyzed as interaction data, for example, when the interactions involve the subscriber, patient, or provider. The interaction data may comprise, for example, short message service (SMS) or email messages, analytics data, clicks, content views, receiving a completed form, two-way conversational history (e.g., via phone, text, form, chat, etc.), patient inaction (e.g., the provider sending a message but the patient not opening the message from the provider, lack of transportation to a medical appointment, or medication confusion), and the like. The method may generate a summary of the interaction data using a large language model (LLM) that employs a neural network trained on massive datasets to understand, interpret and generate text. In some examples, the LLM may use natural language processing (NLP) or other machine-learning (ML) model, or in some examples, manual processing of keywords from a dictionary of risk terms. The LLM may use NLP techniques to process the interaction data into the summary of interaction data by, for example, tokenizing the interaction data into numerical vectors or embeddings then generate new text based on patterns learned during the training process. In some examples, the LLM can be trained (e.g., by implementing a training process) to generate sentiment (e.g., tone for both patient/provider), insights, risks, anomalies, and other analytics in response to a prompt.

In some embodiments, the method may also provide the interaction data as input to a second ML model to generate a risk score of the patient. The risk score, for example, can be associated with the risk of good or poor care, gaps in care or communications, or other inferences/relationships in the interaction data that may not align with the intended treatment of the patient. To generate the risk score, the second ML model may be a model corresponding to logistic regression (e.g., the probability of a binary outcome), tree-based ensembles (e.g., Random Forest, Gradient Boosting Machines like XGBoost and LightGBM, or Extra Trees), or a neural network that has learned to identify textual indicators of risk in the interaction data based on how risks are described in the training data. The risk score may be compared with a threshold value to identify a high risk score or low risk score and corresponding actions to each.

In some embodiments, the risk score, interaction data, and summary of the interaction data may be provided to an agentic tool (e.g., CLAUDE by Anthropic or ChatGPT by OpenAI). An “agentic tool” is a software application that can use NLP techniques and other artificial intelligence (AI) to receive and understand prompts/instructions, interact with applications or APIs and the server/data, monitor the agentic tool's own progress, and self-correct as needed. For example, using the agentic tool, the provider can submit a prompt and receive an answer generated by the agentic tool within the closed data space of the risk score, the summary, and interaction data for the patient. The agentic tool can access the interaction data and restrict access to additional data. The agentic tool can synthesize the data and generate the answer in response to answer the prompt.

In some embodiments, the risk score of the patient may exceed a threshold value. In response to determining that the score exceeds the threshold value, the method may generate/send an alert to entities associated with the patient (e.g., clinicians, subscribers, other providers, etc.) that can identify the comparison between the score and the threshold value. In some examples, the method may determine the next clinical steps to suggest to the provider or patient that can help enable proactive outreach and improved care coordination.

### BRIEF DESCRIPTION OF THE DRAWINGS

The following detailed description makes reference to the accompanying drawings, which are now briefly described.

FIG. 1 is a block diagram of a content management and delivery system, in accordance with some examples of the disclosure.

FIG. 2 is a block diagram of an embodiment of a content management and delivery system coupled to multiple communication channels for use with a content management and delivery system, in accordance with some examples of the disclosure.

FIG. 3 is a block diagram of an embodiment of a content management and delivery system managing content for different geographic locations, in accordance with some examples of the disclosure.

FIG. 4 is a block diagram of an embodiment of a content management and delivery system managing content for a subset of subscribers, in accordance with some examples of the disclosure.

FIG. 5 is a block diagram of an embodiment of a content management and delivery system monitoring access time to a piece of content stored on a server, in accordance with some examples of the disclosure.

FIG. 6 is a block diagram depicting an embodiment of a content management and delivery system managing one-on-one communication between a creator and a subscriber, in accordance with some examples of the disclosure.

FIG. 7 is a block diagram depicting an embodiment of a content management and delivery system checking payment information prior to providing access to a piece of content stored on a server, in accordance with some examples of the disclosure.

FIG. 8 is a block diagram depicting a page of content stored on a server included in a content management and delivery system, in accordance with some examples of the disclosure.

FIG. 9 is a block diagram of a server storing multiple content entries, in accordance with some examples of the disclosure.

FIG. 10 is a block diagram depicting an embodiment of a network system, in accordance with some examples of the disclosure.

FIG. 11 is a block diagram depicting an embodiment of a computer system, in accordance with some examples of the disclosure.

FIG. 12 is a flow diagram depicting an embodiment of a method for operating a server included in a content management and delivery system, in accordance with some examples of the disclosure.

FIG. 13 is an interface providing interaction data with information provided by the server, in accordance with some examples of the disclosure.

FIG. 14 is an interface providing interaction data with patients and providers, in accordance with some examples of the disclosure.

FIG. 15 is an interface providing interaction data for a patient with a risk score in excess of a threshold value, in accordance with some examples of the disclosure.

FIG. 16 is an interface providing interaction data for a patient, in accordance with some examples of the disclosure.

FIG. 17 is an interface providing a summary of the interaction data in response to a prompt, in accordance with some examples of the disclosure.

FIG. 18 is an interface providing sentiment, insights, risks, anomalies, and other interaction data in response to a prompt, in accordance with some examples of the disclosure.

FIG. 19 is an interface providing a tool to generate a new assistant that interacts with the interaction data in response to a prompt, in accordance with some examples of the disclosure.

FIG. 20 is an interface providing examples of summaries of the interaction data, in accordance with some examples of the disclosure.

FIG. 21 is a flow diagram depicting an embodiment of a method for operating a server included in a content management and delivery system, in accordance with some examples of the disclosure.

### DETAILED DESCRIPTION

Managing and delivering content to multiple groups of subscribers can be challenging. Businesses, schools, healthcare companies, and individual content creators can have different needs resulting in a patchwork of platforms. Different ones of the platforms may handle different portions of an overall service. For example, a web-services platform may be used to generate and maintain online content, while mass e-mail platform may be used to contact all subscribers to a particular collection of content.

In some cases, tailoring content to individual or small groups of subscribers may involve changes across multiple platforms that can incur significant time and money. Moreover, some subscriber contact options, e.g., e-mail messages, are often ignored by subscribers resulting in missed opportunities for time-sensitive content.

The embodiments described herein may provide techniques to consolidate management and delivery of content on a single platform. By employing a server configured to allow a creator to upload and organize content, the process of generating, managing, and delivering content can be simplified, saving time and money. Moreover, allowing for easy identification of portions of uploaded content that have associated subscription or access fees, monetization of the uploaded content can also be simplified, further saving on time and money. A communication channel based system can also potentially improve subscriber acknowledgment of notifications, thereby improving return on investment of the uploaded content.

Some embodiments described herein may also identify and analyze interactions with the content on the server. The method may generate a summary of the interaction data by an LLM using NLP techniques or other ML model to process the interaction data into the summary of interaction data. The method may also provide the interaction data as input to a second ML model (e.g., logistic regression, tree-based ensembles, or neural network) to generate a risk score of the patient. The method may implement an agentic tool to generate an answer to the prompt. The provider can submit a prompt and, using the agentic tool, the answer to the prompt may be generated that is based on data within the closed data space of the risk score, the summary, and interaction data for the patient.

In some examples and in response to determining that the risk score of the patient exceeds a threshold value, the method may generate/send an alert to entities associated with the patient (e.g., clinician, subscribers, other providers, etc.). In other examples, the method may determine the next clinical steps to suggest to the provider or patient that helps to enable proactive outreach and improved care coordination.

In some embodiments, a risk score may be generated for an aggregate group of patients/subscribers. For example, patients may individually be associated with a risk score in excess of a threshold value based on their communication history or other interaction data. The set of patients may be identified as having a risk score in excess of the threshold value and may provide the set of patients and their interaction data to the agentic tool. Using the agentic tool, the provider can submit a prompt and receive an answer generated within the closed data space of the risk score, the summary, and interaction data for the set of patients.

By employing a server with the risk score, the summary, and interaction data for the patient or set of patients, along with an agentic tool to query the restricted dataset, the process of identifying a set of patients with a risk score in excess of a threshold value can be simplified, saving time and money. Additionally, the synthesizing of the interaction data by the LLM or other ML model may identify insights that can help predict future actions of the patient based on historical interactions with the server and also find relevant data using the agentic tool. This can help adjust the interactions/treatment suggested to the patient in hopes of improving communications and efficacy of the server overall.

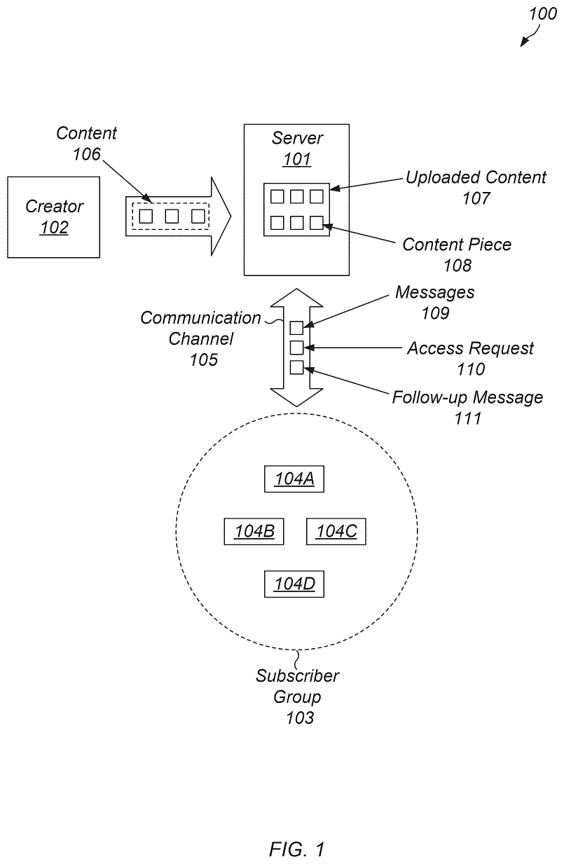

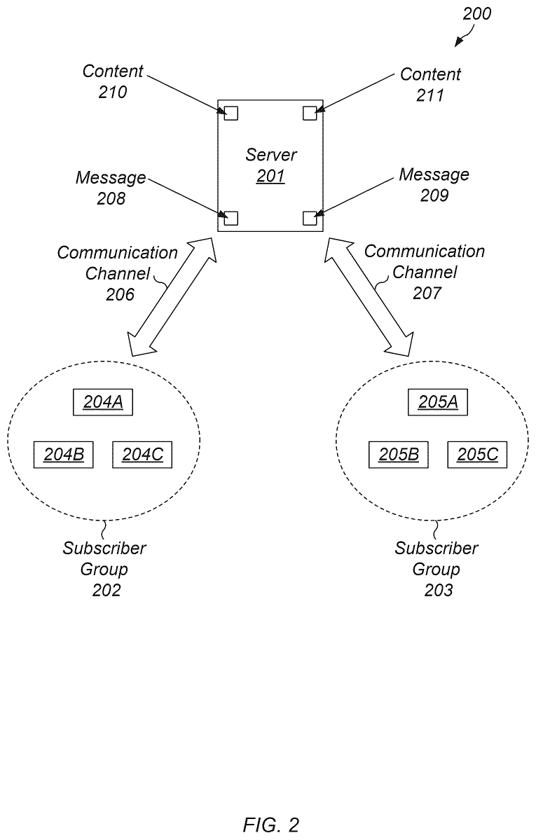

A block diagram of a content management and delivery system is depicted in FIG. 1. As illustrated, content management and delivery system 100 includes server 101 and subscriber group 103, which includes subscribers 104A-104D who are subscribed to communication channel 105. It is noted that although only a single communication channel is depicted in FIG. 1, in other embodiments, server 101 may be configured to manage multiple communication channels.

Server 101 is configured to receive content 106 uploaded by creator 102. In various embodiments, content 106 may include multiple pieces of content associated with communication channel 105. As described below, creator 102 may organize one or more of the pieces of content 106 into one or more pages. Additionally, creator 102 may add properties or tags to any of the pieces of content 106, or any generated pages that can specify levels of access, cost to access, or any other suitable properties.

Server 101 is further configured to send messages 109 to corresponding ones of subscribers 104A-104D. In various embodiments, messages 109 may include a link to one or more pieces of uploaded content 107. Server 101 may be configured to send messages 109 via communication channel 105 using Short Message Service (SMS) or any other suitable communication protocol. It is noted that communication channel 105 may, in some embodiments, employ more than one communication protocol.

Server 101 may be further configured to monitor access to content piece 108 of uploaded content 107. In response to a determination that content piece 108 has been accessed by a particular one of subscribers 104A-104D, server 101 may be configured to send follow-up message 111 via communication channel 105 to the particular one of subscribers 104A-104D. In some embodiments, follow-up message 111 may include a link to a different piece of content of uploaded content 107.

In some embodiments, server 101 may also be configured to receive access request 110 from a given one of subscribers 104A-104D, where access request 110 includes a request to access a given piece of uploaded content 107. As described below, server 101 may check properties associated with the given piece of uploaded content 107 to determine whether or not the given one of subscribers 104A-104D is allowed to access the given piece of uploaded content 107.

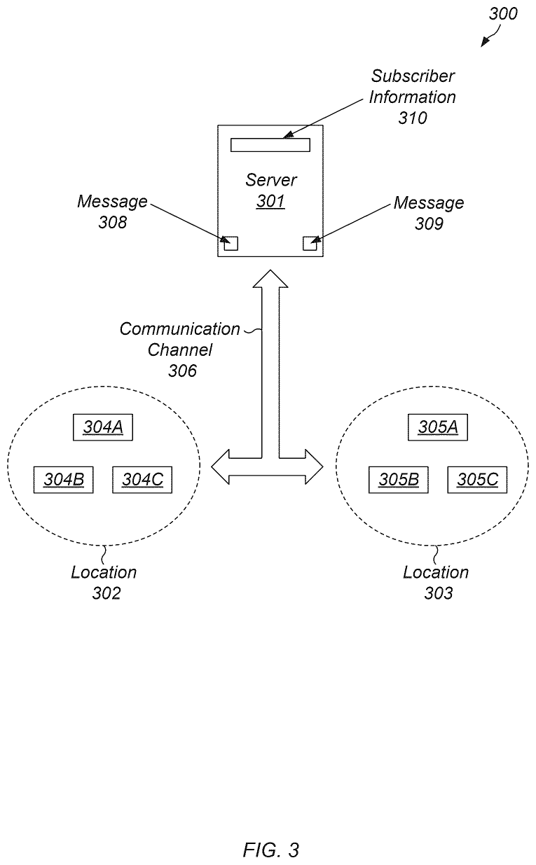

Turning to FIG. 2, a block diagram of a content management and delivery system including multiple communication channels is depicted. As illustrated, server 201 is coupled to communication channels 206 and 207. In various embodiments, server 201 may correspond to server 101 as depicted in FIG. 1.

Subscriber group 202 includes subscribers 204A-204C which subscribe to communication channel 206. In a similar fashion, subscriber group 203 includes subscribers 205A-205C which subscribe to communication channel 207. It is noted that although only two communication channels and two subscriber groups are depicted in the embodiment of FIG. 2, in other embodiments, any suitable number of communication channels and corresponding subscriber groups may be employed. It is further noted that although only three subscribers are depicted as being included in each of subscriber groups 202 and 203, in other embodiments, any suitable number of subscribers may be included in a subscriber group. It is also noted that a given subscriber, e.g., subscriber 204A, may be subscribed to multiple communication channels.

In various embodiments, server 201 may be configured to send message 208 to subscribers 204A-204C, and send message 209 to subscribers 205A-205C. In some embodiments, message 208 may include a link to content 210, while message 209 may include a link to content 211. In other embodiments, content 210 and content 211 may be shared by subscriber groups 202 and 203, in which case either of messages 208 and 209 may include links to both content 210 and 211. It is noted that server 201 may send messages 208 and 209 using SMS, or any other suitable communication protocol.

A block diagram of an embodiment of a content and management delivery system that includes server to manage content delivery for different geographic locations is depicted in FIG. 3. As illustrated, content management and delivery system 300 includes server 301 and subscribers 304A-304C and 305A-305C. In various embodiments, server 301 may correspond to server 101 as depicted in FIG. 1.

Subscribers 304A-304C are located at location 302, while subscribers 305A-305C are located at location 303. Subscribers 304A-304C and 305A-305C are subscribed to communication channel 306. In various embodiments, locations 302 and 303 may correspond to counties, cities, states, countries, or any other suitable geographic location. Information indicative of a subscriber's location may be stored in subscriber information 310 stored on server 301. In some cases, a given one of subscribers 304A-304C and 305A-305C may update their location in response to traveling from one geographic location to another.

Server 301 is configured to send message 308 to subscribers 304A-304C via communication channel 306, and send message 309 to subscribers 305A-305C via communication channel 306. In various embodiments, message 308 may include information specific to location 302, while message 309 may include information specific to location 303. For example, message 308 may include information indicative of a particular concert date in a particular city corresponding to location 302, while message 309 may include information indicative of a different concert date in a different city corresponding to location 303.

Although the embodiment depicted in FIG. 3 describes sending messages based on geographic locations, in other embodiments, messages may be sent by server 301 based on any suitable information available in subscriber information 310. For example, in some embodiments, subscriber information 310 may include corresponding ages for subscribers 304A-304C and 305A-305C, and server 301 may be configured to send different messages to different age groups of subscribers 304A-304C and 305A-305C. In other embodiments, subscriber information 310 may include medical information (e.g., prescriptions, surgical information, diagnosed diseases, etc.) for subscribers 304A-304C and 305A-305C, which can be used to identify one or more subscribers for message delivery. In other embodiments, combinations of subscriber information (e.g., subscribers over a certain age located in a particular city) may be used to identify subscribers for message delivery.

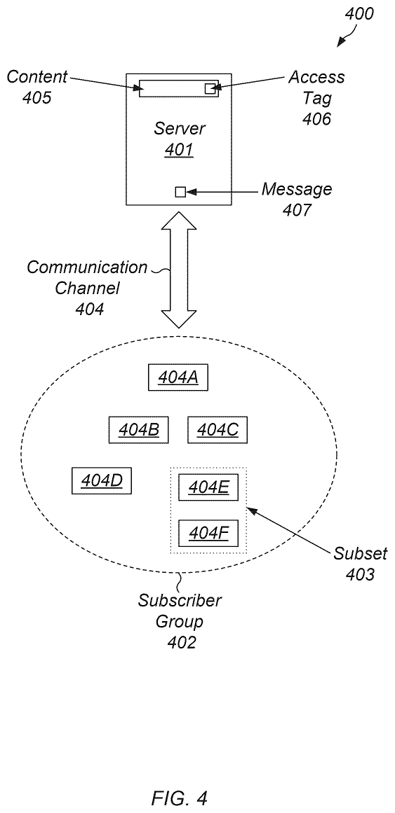

Turning to FIG. 4, a block diagram of an embodiment of a content management and delivery system that includes a server managing content for a subset of subscribers is depicted. As illustrated, content management and delivery system 400 includes server 401 and subscribers 404A-404F included in subscriber group 402. It is noted that server 401 may correspond to server 101 as depicted in FIG. 1.

Server 401 is configured to store content 405, which includes access tag 406. In various embodiments, access tag 406 includes information indicative of which of subscribers 404A-404F have accessed content 405. For example, access tag 406 may indicate that subscribers 404A-404D have accessed content 405, while subscribers 404E and 404F have yet to access content 405.

In various embodiments, server 401 is further configured to send, via communication channel 404, message 407 to subscribers 404E and 404F in response to a determination that subscribers 404E and 404F have not accessed content 405 based on access tag 406. Message 407 can include a reminder to access content 405.

By tracking access to a particular piece of content, server 401 can determine whether a particular subscriber has accessed a particular piece of content. For example, in some medical applications, post-operative surgical patients may be sent a message that links them to content that includes information for recovery, follow-up appointments, etc. If such a patient does not access that content, server 401, as described above, may be configured to send a reminder message to the patient, thereby increasing the likelihood that post-operative recovery goes smoothly.

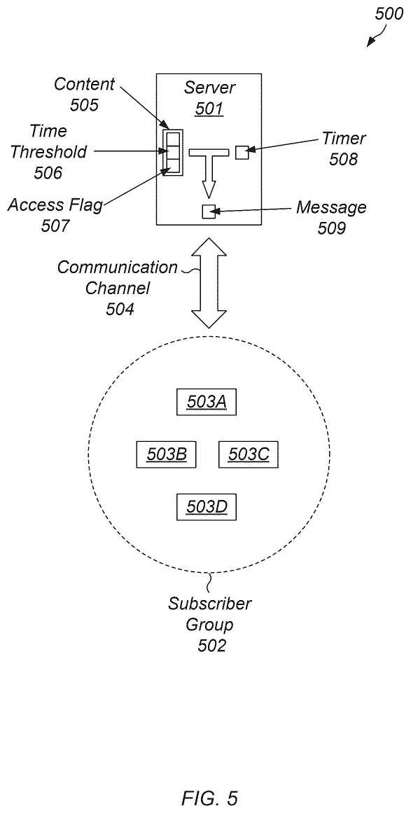

Turning to FIG. 5, a block diagram of a content management and delivery system that monitors times at which content is accessed is depicted. As illustrated, content management and delivery system 500 includes server 501 and subscriber group 502. In various embodiments, server 501 may correspond to server 101 as depicted in FIG. 1.

Subscriber group 502 includes subscribers 503A-503D who are subscribed to communication channel 504. In various embodiments, any of subscribers 503A-503D can access content 505 in response to receiving a message from server 501.

Server 501 is configured to monitor access flag of 507 content 505 to determine whether or not content 505 has been accessed by particular ones of subscribers 503A-503D. In response to a determination that timer 508 exceeds time threshold 506 and access flag 507 indicates that content 505 has not been accessed, server 501 may be further configured to send message 509 to a given one of subscribers 503A-503D. In some embodiments, message 509 may include a reminder to access content 505.

In various embodiments, access flag 507 may include information indicative of which of subscribers 503A-503D have accessed content 505. In such cases, server 501 may track time to access content 505 on a per subscriber basis. When a value of timer 508 exceeds time threshold 506, server 501 may send reminder messages to only subscribers who have not accessed content 505.

Although only a single piece of content is depicted in the embodiment of FIG. 5, in other embodiments server 501 may be configured to store any suitable number of pieces of content. It is noted that although content 505 is depicted as having a single time threshold, in other embodiments, content 505 may include multiple time thresholds which can trigger different reminder messages being sent as the multiple time thresholds are exceeded.

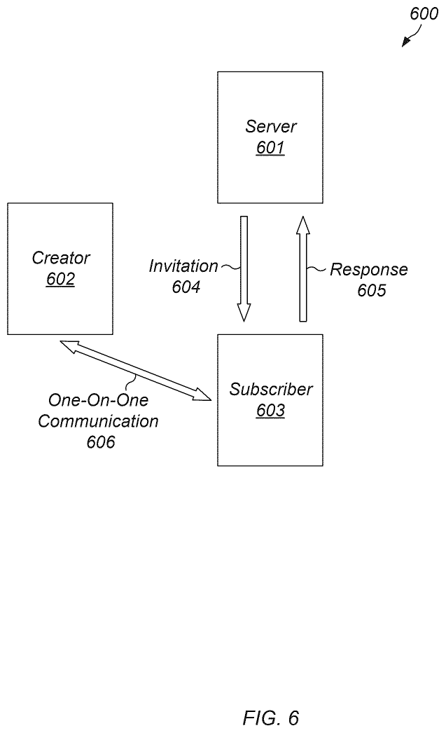

Turning to FIG. 6, a block diagram of a content management and delivery system that includes one-on-one communication is depicted. As illustrated, content management and delivery system 600 includes server 601, creator 602, and subscriber 603. Although only one creator and one subscriber are depicted in the embodiments of FIG. 6, in other embodiments, content management and delivery system 600 may include any suitable number of creators and subscribers.

Server 601 may be configured to send invitation 604 to subscriber 603. In various embodiments, invitation 604 may include an invitation to participate in one-on-one communication 606 with creator 602. Server 601 may be configured to send invitation 604 via SMS or any other suitable communication protocol. In some embodiments, server 601 may be configured to send invitation 604 in response to a determination that a particular condition has been met. For example, server 601 may send invitation 604 in response to a determination that a particular piece of content stored on server 601 has not been accessed within a specified period of time.

Subscriber 603 can respond to invitation 604 with response 605. In various embodiments, response 605 may be an affirmative or negative response to the invitation for one-on-one communication 606 with creator 602. Subscriber 603 can send response 605 using SMS or any other suitable communication protocol.

Server 601 is configured, in response to a determination that response 605 is an affirmative response, to initiate one-on-one communication 606 between creator 602 and subscriber 603. In various embodiments, to initiate one-on-one communication 606, server 601 may be further configured to send a message to creator 602 indicating that response 605 is affirmative so that creator 602 can contact subscriber 603. Alternatively, server 601 may setup a tele-conference and send links to participate in the tele-conference to both creator 602 and subscriber 603.

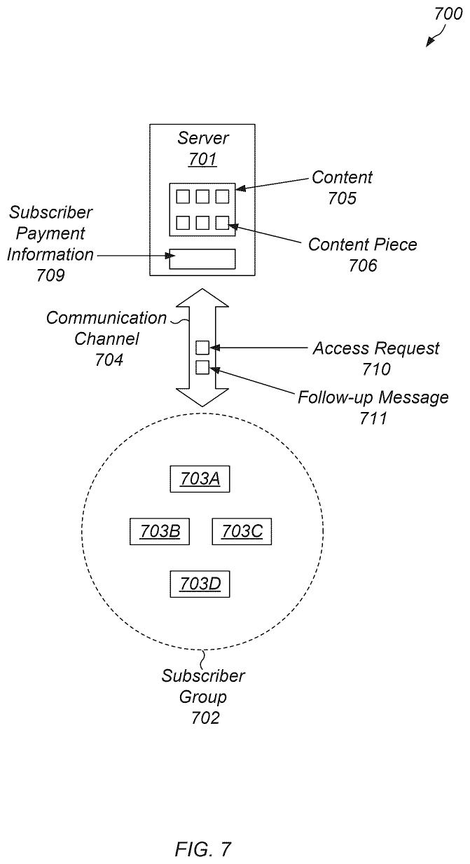

Turning to FIG. 7, a block diagram of a content management and delivery system for tracking payment information is depicted. Content management and delivery system 700 includes server 701, and subscriber group 702 that includes subscribers 703A-703D who are subscribed to communication channel 704. Although only a single subscriber group and communication channel is depicted in FIG. 7, in other embodiments, any suitable number of communication channels and corresponding subscriber groups may be managed by server 701.

In various embodiments, a particular one of subscribers 703A-703D may send access request 710 to server 701 via communication channel 704 to access content piece 706 included in content 705 stored on server 701. It is noted that, in some embodiments, access request 710 may take the form of a “click” on a link included in other pieces of content 705. In response to receiving access request 710, server 701 is configured to check cost information associated with content piece 706. If the cost information indicates that a certain fee is associated with content piece 706, server 701 is configured to check subscriber payment information 709 to determine whether or not the particular one of subscribers 703A-703D has made the necessary payment to access content piece 706.

In cases where the particular one of subscribers 703A-703D has made the necessary payment to access content piece 706, server 701 is configured to grant access to content piece 706. Alternatively, in cases where the particular one of subscribers 703A-703D has not paid to access content piece 706, server 701 will not grant access to content piece 706 and will send follow-up message 711 via communication channel 704 to the particular one of subscribers 703A-703D. In some cases, follow-up message 711 may include a notification that access cannot be granted and provide a link to a page or site where payment can be made.

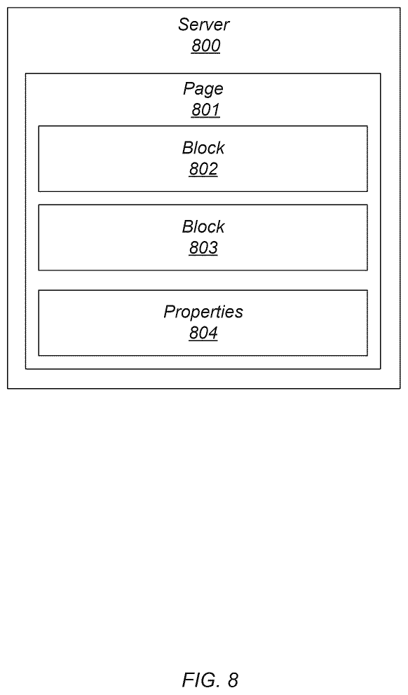

In some cases, once a creator has uploaded content to a server, the creator can organize and present the content as one or more pages. A block diagram of a server storing a page of content is depicted in FIG. 8. As illustrated, server 800 is configured to store page 801. In various embodiments, server 801 may correspond to server 101 as depicted in FIG. 1. Although server 801 is depicted as storing a single page, in other embodiments, server 800 can be configured to store any suitable number of pages.

Page 801 includes block 802, block 803, and properties 804. Blocks 802 and 803 can include a variety of content uploaded by a creator (e.g., creator 102 as depicted in FIG. 1). In various embodiments, blocks 802 and 803 may include images, text, video, or any other suitable information. In various embodiments, the creator may arrange blocks 802 and 803 in an order to be displayed when a subscriber accesses page 801. In some embodiments, the creator may create and manipulate page 801 using a graphical user interface (“GUI”) that accesses server 800. Although page 801 is depicted as including only two blocks, in other embodiments, page 801 may include any suitable number of blocks.

Properties 804 can, in various embodiments, include multiple properties applied to page 801. For example, in some cases, properties 804 may indicate a subscription level needed to access page 801. Alternatively, properties 804 may include a cost associated with an access to page 801. In some embodiments, properties 804 can include a recommendation for another page to access, time threshold information should information in blocks 802 and 803 be time sensitive, or any other suitable information relating to the content included in page 801.

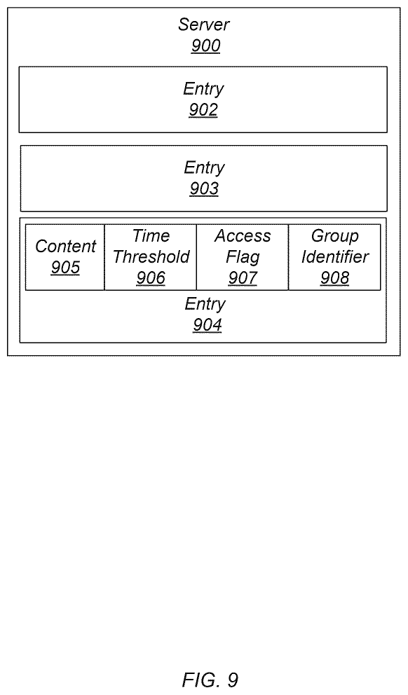

Turning to FIG. 9, a block diagram of a server storing multiple entries of content is depicted. As illustrated, server 900 is configured to store entries 902-904. It is noted that, in various embodiments, server 900 may correspond to server 101 as depicted in the embodiment of FIG. 1. Although server 900 is depicted as storing three entries, in other embodiments, server 900 can store any suitable number of entries.

Entry 904 includes content 905, time threshold 906, access flag 907, and group identifier 908. It is noted that, in various embodiments, the internal structure of entries 902 and 903 may be the same as entry 904, or may include any suitable subset of the type of information included in entry 904.

Content 905 can include a variety of data. In some cases, content 905 can include various media files (e.g., a MP3 file, a WAV file, or the like). In other cases, content 905 can include text or word processing files, spreadsheet files, or any suitable combination thereof.

Time threshold 906 includes data indicative of a particular duration of time. In some embodiments, time threshold 906 may correspond to time threshold 506 as depicted in FIG. 5, and may be used to send reminder messages when a time during which content 905 has not been accessed exceeds time threshold 906. In other embodiments, time threshold 906 may include data indicative of a future date that may be used to send reminder messages if content 905 has not been accessed by the future date included in time threshold 906.

Access flag 907 includes information indicative of which subscribers to a particular communication channel have accessed content 905. In various embodiments, a unique identifier corresponding to a particular subscriber may be added to access flag 907 by server 900 in response to the particular subscriber accessing content 905. In cases where content 905 is shared between multiple communication channels, the unique identifier may include data indicative of a communication channel to which the particular subscriber belongs.

Group identifier 908 includes information regarding subsets of a subscriber group for the communication channel associated with content 905. In various embodiments, group identifier 908 may identify which subscribers of the subscriber group have paid for access to content 905. Alternatively, group identifier 908 may include information identifying different subsets of the subscriber group associated with corresponding geographic locations.

It is noted that information stored in entry 904 is an example. In other embodiments, additional information, or different information, may be included with content 905.

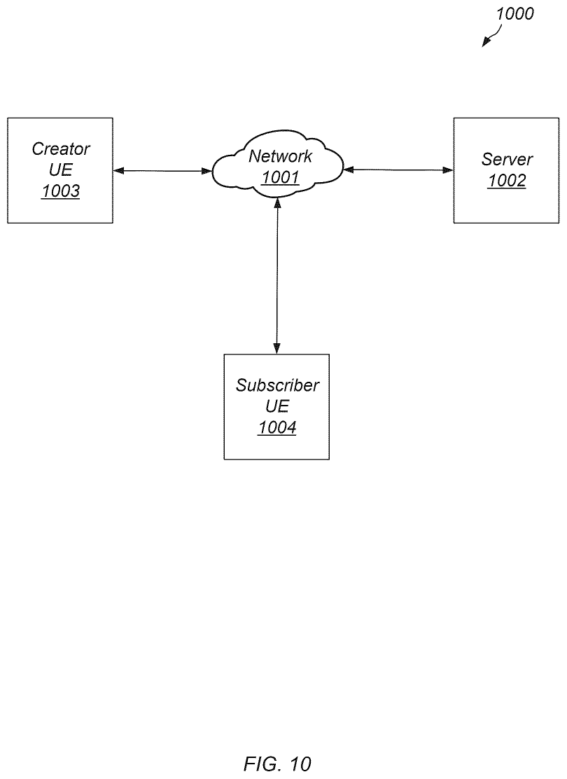

Turning to FIG. 10, a block diagram of a network system is depicted. As illustrated, network system 1000 includes network 1001, server 1002, creator user equipment 1003 (denoted “creator UE 1003”), and subscriber user equipment 1004 (denoted “subscriber UE 1004”). Although only one creator UE and one subscriber UE are depicted in the embodiment of FIG. 10, in other embodiments, any suitable number creator UEs and subscriber UEs may be employed.

Network 1001 can be any type of network, such as, but not limited to, a wireless network, cellular network, the Internet, and the like. As disclosed herein, network 1001 can facilitate connectivity of server 1002, creator UE 1003, and subscriber UE 1004. In various embodiments, messages may be transmitted over network 1001 using any suitable communication protocol (e.g., SMS).

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular, or any combination thereof. Likewise, sub-networks, which may employ differing architectures, or may be compliant or compatible with differing protocols, may interoperate within a larger network.

Creator UE 1003 may be configured to upload content to server 1002 and manage uploaded content as described above. In some embodiments, creator UE 1003 may be configured to upload content via network 1001. In other embodiments, creator UE 1003 may upload content to server 1002 via a direct wired or wireless connection.

Server 1002 may, in various embodiments, correspond to server 101 as depicted in FIG. 1. In various embodiments, server 1002 may be configured to store multiple pieces of content which are associated with corresponding communication channels. Additionally, server 1002 may be configured to send messages to subscriber UE 1004, monitor access to content, or any of the other operations described above in regards to servers.

Subscriber UE 1004 may be configured to receive messages from server 1002. In some embodiments, subscriber UE 1004 may be configured to send acknowledgements to server 1002, as well as communicate with creator UE 1003 in a one-on-one communication session. In various embodiments, subscriber UE 1004 may be implemented using a mobile phone, tablet, laptop, personal computer, and the like. In some embodiments, subscriber UE 1004 may be equipped with a cellular, wireless, or wired transceiver depending on the implementation of network 1001.

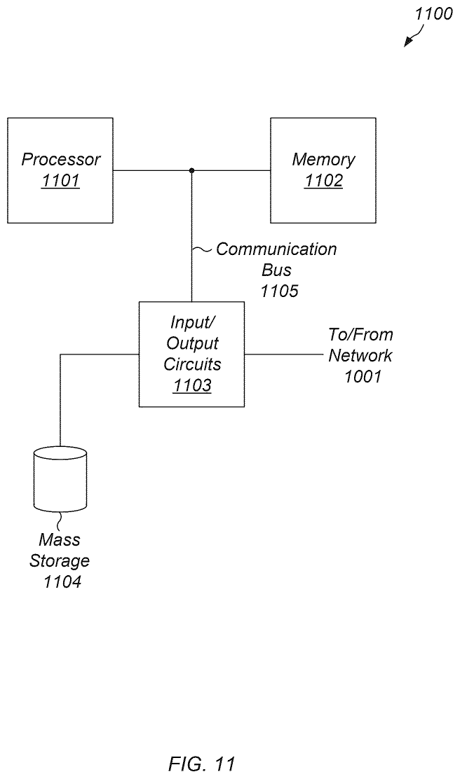

A block diagram of a computer system is depicted in FIG. 11. As illustrated, computer system 1100 includes processor 1101, memory 1102, input/output circuits 1103, and mass storage 1104. Processor 1101, memory 1102, and input/output circuits 1103 are coupled together via communication bus 1105. It is noted that in various embodiments, computer system 1100 may correspond to any of the servers or user equipment described above, and may be configured for use in a desktop computer, server, or in a mobile computing application such as a tablet, laptop computer, or wearable computing device.

Some computer systems may include additional components not shown, such as graphics processing unit (GPU) devices, cryptographic co-processors, artificial intelligence (AI) accelerators, or other peripheral devices. In cases where computer system 1100 corresponds to a UE (e.g., subscriber UE 1004), computer system 1100 may further include a display, keypad, an audio interface, and the like, to allow a user to interface with computer system 1100.

Processor 1101 may, in various embodiments, be representative of a general-purpose processor configured to perform various operations in response to executing program or software instructions. For example, processor 1101 may be a central processing unit (CPU) such as a microprocessor, a microcontroller, an application-specific integrated circuit (ASIC), or a field-programmable gate array (FPGA). While a single processor is depicted in the embodiment of FIG. 11, in other embodiments, multiple processors may be employed. It is noted that, in some embodiments, processor 1101 may include multiple processor cores configured to work in unison on independently to execute a program or software instructions.

Memory 1102 may, in various embodiments, include any suitable type of memory such as dynamic random-access memory (DRAM), static random-access memory (SRAM), read-only memory (ROM), electrically erasable programmable read-only memory (EEPROM), non-volatile memory, for example. Although a single memory is depicted in the embodiment of FIG. 11, in other embodiments, any suitable number of memories may be employed.

Input/output circuits 1103 may be configured to coordinate data transfer between computer system 1100 and one or more peripheral devices, such as mass storage 1104. Such peripheral devices may include, without limitation, storage devices (e.g., magnetic or optical media-based storage devices including hard drives, tape drives, CD drives, DVD drives, etc.), audio processing subsystems, or any other suitable type of peripheral devices. In some embodiments, input/output circuits 1103 may be configured to implement a version of Universal Serial Bus (USB) protocol, IEEE 1394 (Firewire®) protocol, Peripheral Component Interface Express (PCIE), and the like.

Input/output circuits 1103 may also be configured to coordinate data transfer between computer system 1100 and one or more devices (e.g., other computing systems or integrated circuits) coupled to computer system 1100 via a network. In some embodiments, input/output circuits 1103 may be configured to perform the data processing necessary to implement an Ethernet (IEEE 802.3) networking standard such as Gigabit Ethernet or 10-Gigabit Ethernet, for example, although it is contemplated that any suitable networking standard may be implemented. In some embodiments, input/output circuits 1103 may be configured to implement multiple discrete network interface ports.

Mass storage 1104 may include a non-transitory computer readable storage medium configured to store program or software instructions, as well as content uploaded by a creator. In some cases, mass storage 1104 may include an installation medium, e.g., a CD-ROM, floppy disks, or a tape device. Alternatively, or additionally, mass storage 1104 may include DRAM, double data-rate random-access memory (DDR RAM), SRAM, extended data out random-access memory (EDO RAM), Rambus RAM, or any other suitable type of memory. In various embodiments, mass storage 1104 may include non-volatile memory such as flash memory, magnetic media, e.g., a hard drive, or optical storage, registers, or other similar types of memory elements, etc. It is noted that mass storage 1104 may include any suitable combination of the memory mediums described above, which may reside in different locations, e.g., different computer systems that are connected via a network.

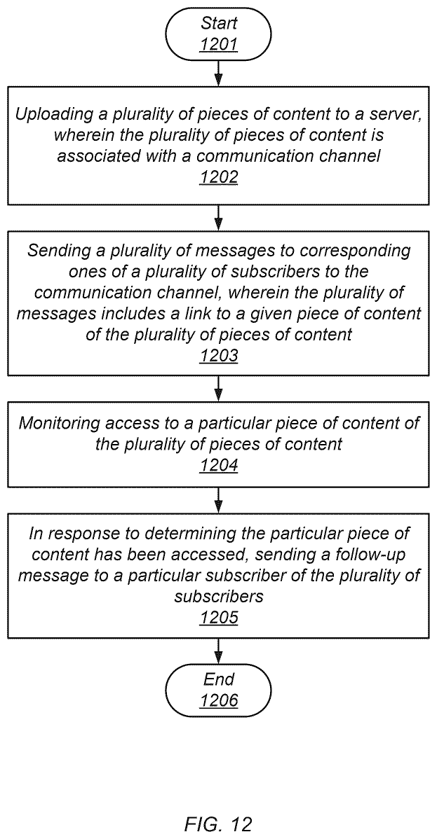

Turning to FIG. 12, a flow diagram depicting an embodiment of a method for operating a server to manage and deliver content to subscribers is illustrated. The method, which may be applied to various servers, e.g., server 101 as depicted in FIG. 1, begins in block 1201.

The method includes uploading a plurality of pieces of content to a server (block 1202). In various embodiments, the plurality of pieces of content is associated with a communication channel. In different embodiments, uploading the plurality of pieces of content includes tagging at least one piece of content of the plurality of pieces of content with information indicative of a cost associated with accessing the at least one piece of content.

In some embodiments, uploading the plurality of pieces of content includes tagging at least one piece of content of the plurality of pieces of content with information indicative of a subset of the plurality of subscribers. In some cases, the information indicative of the subset of the plurality of subscribers includes geographical location information. The method may, in some embodiments, include sending respective messages to the subset of the plurality of subscribers, where the respective messages include corresponding links to the at least one piece of content.

The method further includes sending a plurality of messages to corresponding ones of a plurality of subscribers to the communication channel (block 1203). In various embodiments, the plurality of messages includes a link to a given piece of content of the plurality of pieces of content.

The method also includes monitoring access to a particular piece of content of the plurality of pieces of content (block 1204). In some cases, monitoring access to the particular piece of content may include setting an access flag for the particular piece of content in response to determining that the particular piece of content being accessed. In some embodiments, the access flag may include information indicative of a particular subscriber that accessed the particular piece of content. Alternatively, or additionally, the access flag may include information indicative of a number of times the particular subscriber accessed the particular piece of content.

The method further includes, in response to determining the particular piece of content has been accessed, sending a follow-up message to a particular subscriber of the plurality of subscribers (block 1205). In some embodiments, the follow-up message may include a link to a different piece of content. Alternatively, or additionally, the follow-up message may include an invitation to initiate one-on-one communication between the particular subscriber and a creator of the content. In other embodiments, sending the follow-up message includes sending a Short Message Service (SMS) message.

In some embodiments, the method may also include tracking an amount of time a different piece of content of the plurality of pieces of content remains un-accessed. In such cases, the method may additionally include, in response to determining that the amount of time exceeds a threshold value (e.g., time threshold), sending a reminder message to a different subscriber of the plurality of subscribers.

In other embodiments, the method may further include receiving, from a given subscriber of the plurality of subscribers, a request to access the different piece of content of the plurality of pieces of content. In such cases, the method may also include checking payment information associated with the given subscriber prior to granting access to the different piece of content. The method concludes in block 1206.

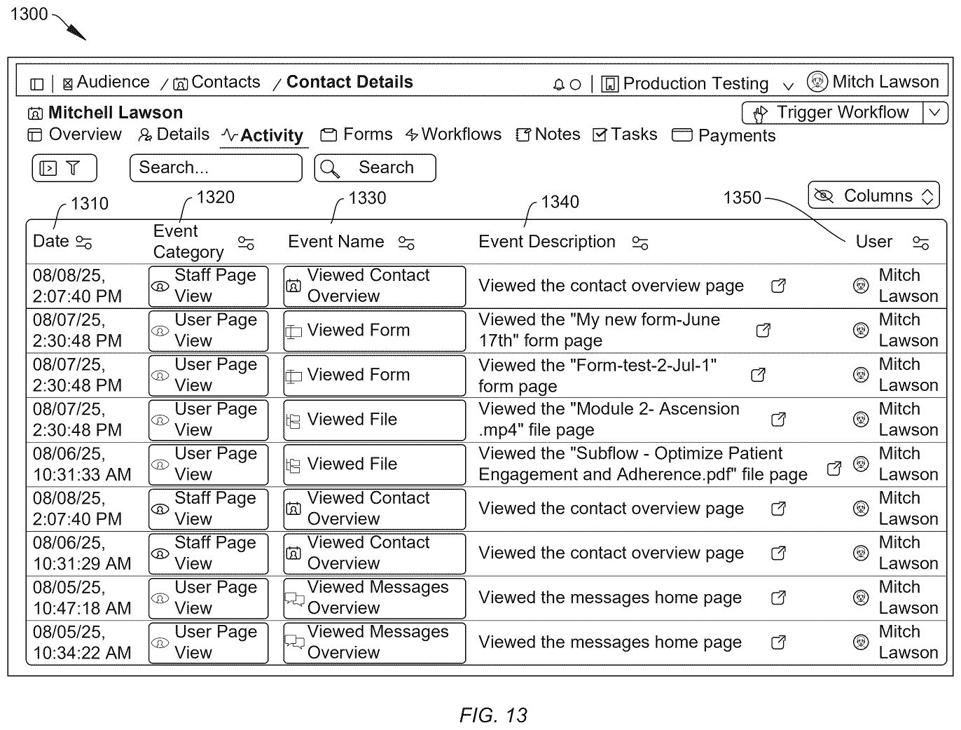

Turning to FIG. 13, an interface providing interaction data with information provided by the server is depicted. For example, in interface 1300, the interaction data stored in server is provided (e.g., server 101 in FIG. 1, server 501 in FIG. 5, or server 900 in FIG. 9). The interface may provide interaction data for a single user. The interaction data may comprise the date of the interaction/event 1310, event category 1320, event name 1330, event description 1340, and name of the subscriber/patient 1350. The interaction data may include any action or event that is performed on the server with an identification of the entities involved (e.g., patient and clinician).

In some examples, an access flag associated with the interaction/event may be stored by the server (e.g., access flag 507 in FIG. 5 or access flag 907 in FIG. 9). The access flag may be activated when the particular piece of content has been accessed by a user of the system, including the subscriber, patient, or provider.

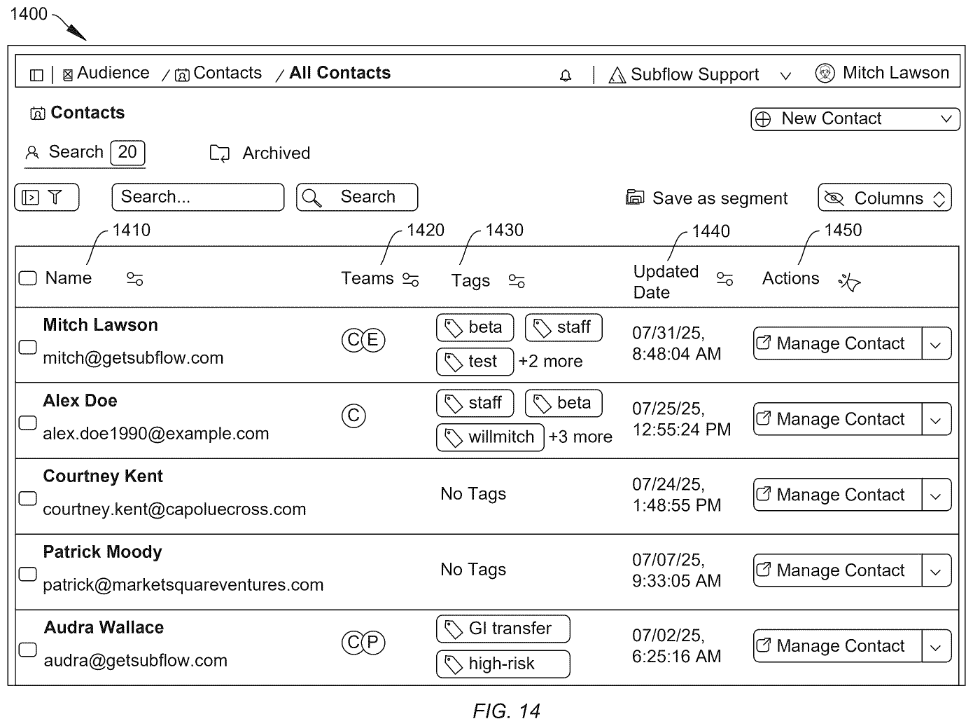

Turning to FIG. 14, an interface providing interaction data with patients and providers is depicted. For example, in interface 1400, the interaction data for a set of subscribers/patients is provided. The interaction data may comprise the name of the subscriber/patient 1410, team 1420, tag 1430, updated date 1440, and actions 1450.

The interaction data in this example may be associated with an event that corresponds to a risk score in excess of a threshold value (e.g., likely to miss an upcoming event, not opening messages, etc.). The event can be tagged (tag 1430) to identify the corresponding risk. In response to the identification of the risk, the patient (subscriber/patient 1410) may be assigned to a provider (team 1420) to follow up or send additional communications. The date of each follow-up action may be added to the interaction data (updated date 1440). These additional actions may be performed in hopes of lowering the risk score in comparison to the threshold value.

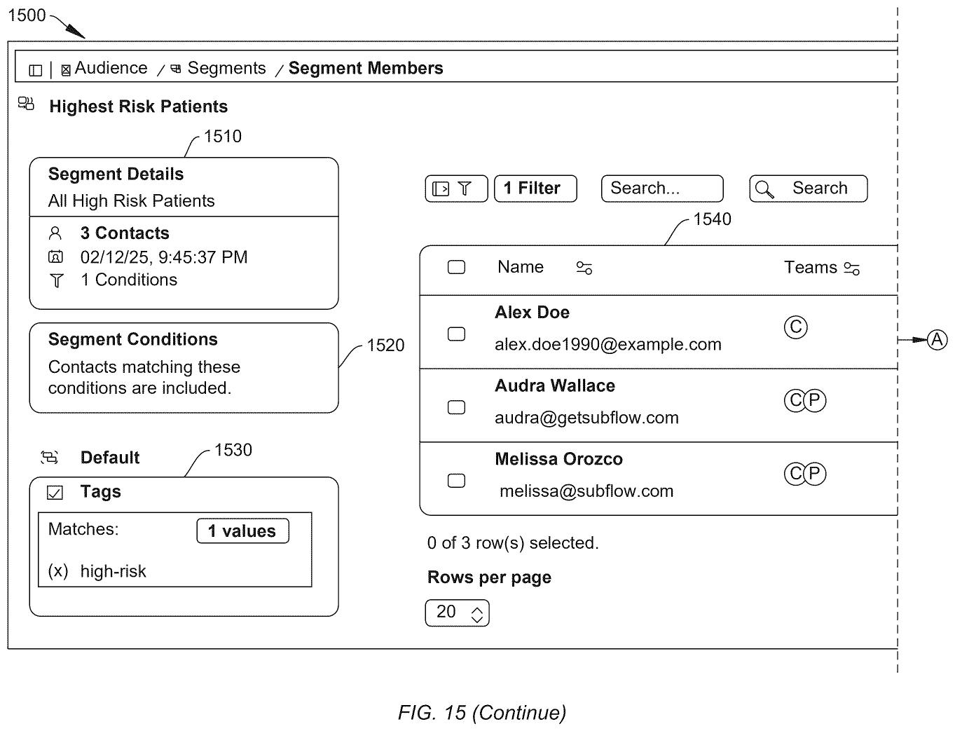

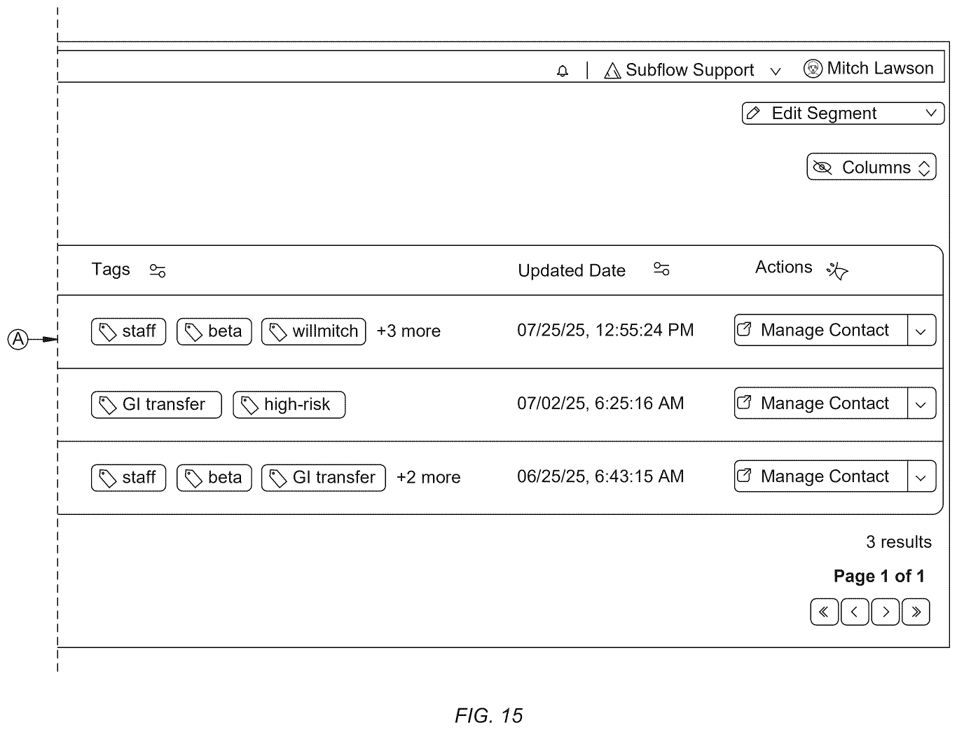

Turning to FIG. 15, an interface providing interaction data for a patient with a risk score in excess of a threshold value, in accordance with some examples of the disclosure. For example, in interface 1500, the segment/group of subscribers/patients 1510 with a risk score in excess of a threshold value may be grouped and provided to the interface. As discussed herein, a ML model may be used to generate a risk score of the patient and each of the subscribers/patients whose risk scores exceed the threshold value may be provided to the interface 1500.

In some embodiments, the interface 1500 can include additional information about the patients/subscribers associated with the high risk score. For example, the segment conditions 1520 and any corresponding tags 1530 associated with the segment/group of patients/subscribers 1510 may also be provided. In some examples, the individual patients 1540 in the segment/group of patients/subscribers 1510 are also provided with information that is similar to the interface in FIG. 14 to show more detail on each patient.

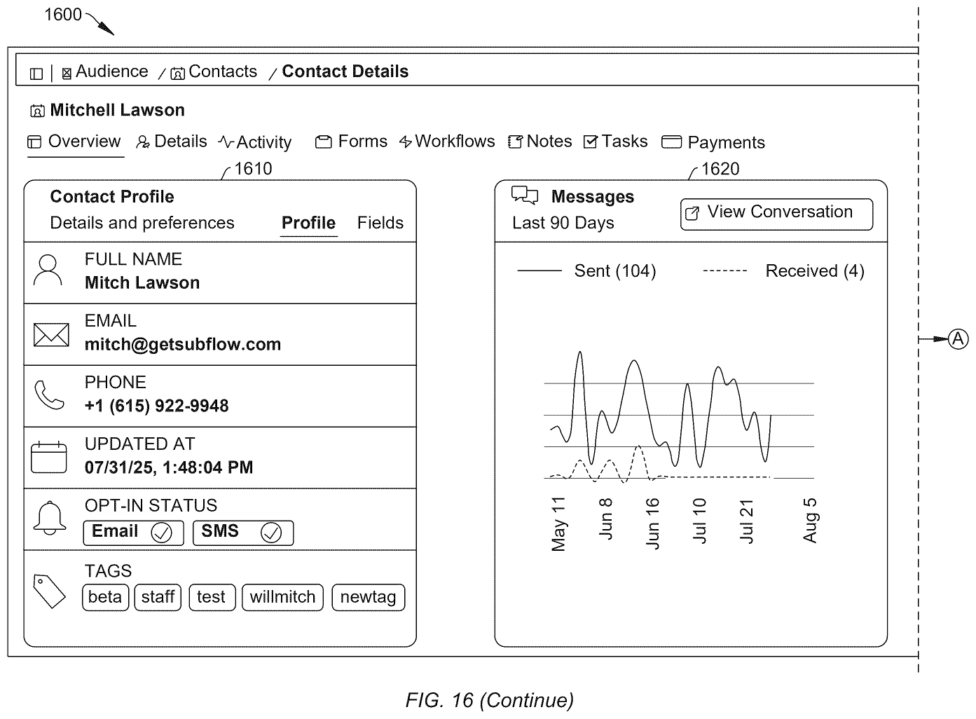

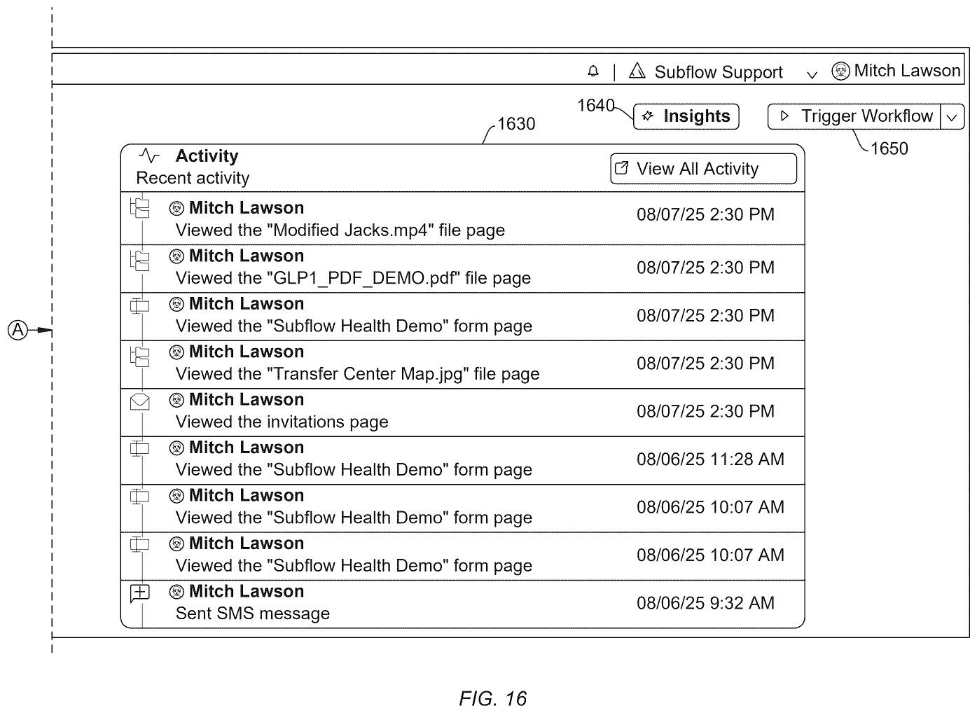

Turning to FIG. 16, an interface providing interaction data for a patient is depicted. For example, in interface 1600, the interaction data for a single subscriber/patient is provided. The interaction data may comprise the contact profile and additional information about the subscriber/patient 1610, a summary of communications 1620 with the subscriber/patient, and detailed interaction data 1630 with the subscriber/patient. The interaction data 1630 may be similar to the information provided to the interface in FIG. 14 and FIG. 15.

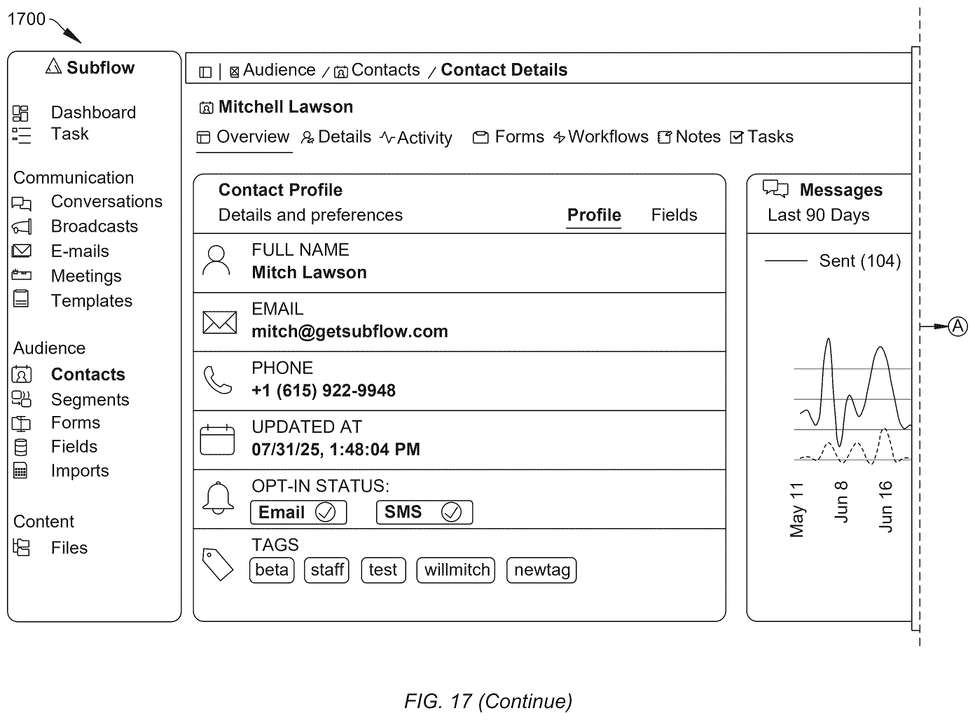

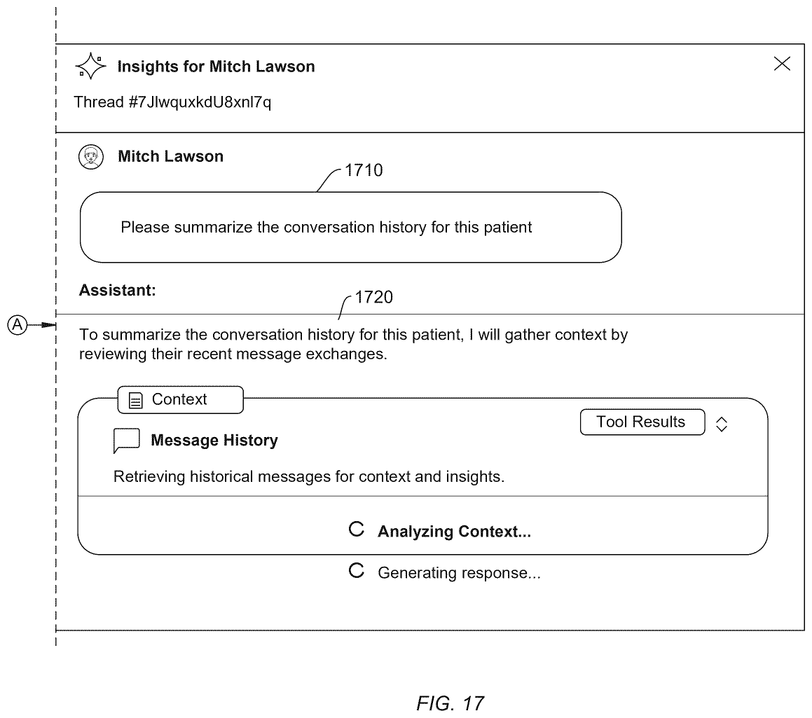

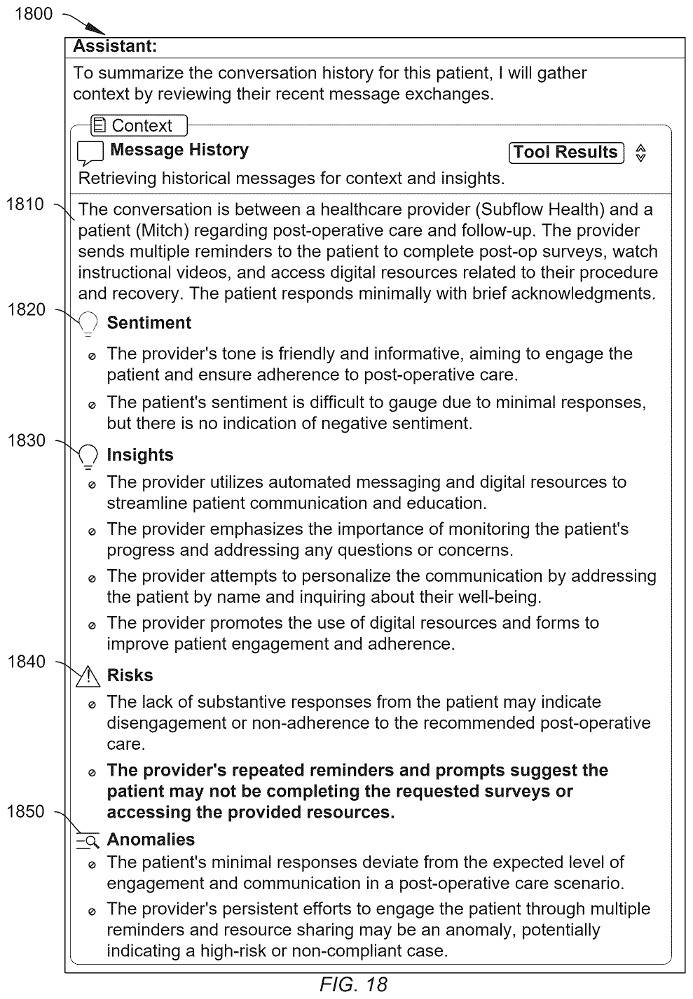

A set of tools 1640, 1650 may also be provided to the interface 1600. A first tool 1640 may initiate an insights process using the interaction data 1630. For example, in response to activating the first tool 1640, the server can generate a summary of the interaction data using an LLM that uses NLP techniques to process the interaction data into the summary of interaction data, or in some examples, manual processing of keywords from a dictionary of risk terms. Additional detail about the insights process is provided in FIG. 17 and FIG. 18.

A second tool 1650 may initiate a workflow process using the interaction data 1630. For example, the risk score, interaction data, and summary of the interaction data may be provided to an agentic tool (e.g., CLAUDE by Anthropic or ChatGPT by OpenAI). Using the agentic tool, the provider can submit a prompt and receive an answer generated within the closed data space of the risk score, the summary, and interaction data for the patient. In another example, the workflow process may generate/send an alert to one or more entities associated with the patient (e.g., clinician, subscribers, other providers, etc.) or determine the next clinical steps to suggest to the provider or patient. The next clinical step can include a proactive outreach and improved care coordination.

In a non-limiting illustration, the event can be tagged to identify the corresponding risk. In response to the identification of the risk, the system may generate a next clinical step to perform with the patient. For example, the patient may be assigned to a provider to follow up or send additional communications. The date of each follow-up action may be added to the interaction data. These additional actions may be performed in hopes of lowering the risk score in comparison to the threshold value.

Turning to FIG. 17, an interface 1700 providing a summary of the interaction data in response to a prompt 1710 is depicted. For example, the LLM may previously generate a summary of the interaction data that is stored on the server. The interface 1700 may provide additional functionality to interact with the interaction data or summary.

For example, using the agentic tool, the provider can submit a prompt 1710 and the agentic tool can analyze the interaction data and summary in response to the prompt. In this example, the prompt includes a question to generate a summary of the conversation history with the patient (e.g., “please summarize the conversation history for this patient”). The agentic tool can generate a summary of the analytics process 1720 or a description of the initiation of the insights workflow (e.g., “To summarize the conversation history for this patient, I will gather context by reviewing their recent message exchanges.”).

In some examples, the agentic tool may compare terms/tokens in the interaction history with a dictionary of risk terms that are associated to different risk scores or other levels of risk. Illustrative risk terms may include “miss appointment,” “sick,” or “hurt,” or actions/events corresponding to risk, including opening/not opening a message or link to an instructional video, or responding/not responding to communications from the provider.

The interaction data in this example may be associated with an event that corresponds to a risk score in excess of a threshold value (e.g., likely to miss an upcoming event, not opening messages, etc.). The event can be tagged (tag 1430) to identify the corresponding risk. In response to the identification of the risk, the patient (subscriber/patient 1410) may be assigned to a provider (team 1420) to follow up or send additional communications. The date of each follow-up action may be added to the interaction data (updated date 1440). These additional actions may be performed in hopes of lowering the risk score in comparison to the threshold value.

The response to the prompt may be provided to the interface 1800, as shown in FIG. 18, and may include a summary 1810 of the message history, sentiment 1820, insights 1830, risks 1840, anomalies 1850, and other analytics in response to the prompt. This information may be generated by an LLM or other ML model through a combination of pattern recognition, context understanding, and probabilistic inference.

For example, the training process of the LLM may identify tokens/terms (used interchangeably) in the interaction data that is generated into a context of the interaction data. The tokens/terms in the interaction data may be labeled with sentiments (e.g., positive, negative, neutral) during the training process. The training process may use the labeled training data with sentiments to determine a pattern in the interaction data. The pattern may include certain tones, phrases, punctuation, and sentence structure corresponding to specific sentiments. In some examples, the overall sentiment of the interaction data may be labeled as well. During an inference process, the classification of the interaction data may be determined in response to a prompt (e.g., “What is the sentiment of the interaction data for this patient.”).

The context may be used as the summary 1810 of the interaction data or individual communication between the provider and patient (e.g., a context of a single phone call or email chain). The LLM may use the transformer to understand the relationship between the terms/token, sentences, etc. The summary 1810 may be a sentence-based description of the pattern identified by the LLM/transformer. In this example, the summary 1810 includes an explanation of the conversation between the patient and provider (e.g., “the conversation is between the healthcare provider . . . and a patient . . . regarding post-operative care and follow-up.”) and the tone/sentiment of that conversation (e.g., “The provider sends multiple reminders to the patient to complete post-op surveys, watch instructional videos, and access digital resources related to their procedure and recovery. The patient responds minimally with brief acknowledgements.”).

Sentiment 1820 may include the labeled tokens/terms that were learned from the training process (e.g., positive, negative, neutral). Using the sentiment, the LLM may generate a sentence-based description of the sentiment identified by the LLM (e.g., “The provider's tone is friendly and informative. . . . The patient's sentiment is difficult to gauge due to minimal responses . . . ”).

Insights 1830 may include a meaning, implication, connection, etc. in the interaction data overall or for each interaction individually (e.g., a context of a single phone call or email chain). For example, the LLM may learn which semantic structures that normally include insights (e.g., during the training process), and from that, may identify a topic, pattern, cause/effect, contrast/contradiction, generalization, etc. in the received interaction data. In some examples, the LLM can also learn to identify a ranking of the insights as more or less insightful (e.g., using a range of values or a score) and use the learned ranking to create a summary of insights to provide to the interface.

Risks 1840 may determine the textual indicators of risk in the interaction data based on how risks are described in the training data. For example, using the training process, the LLM may recognize patterns, phrases, communications, etc. that may be similar to the training data to generate a summary of the positive or negative outcomes, uncertainty, potential harm, etc. in the interaction data. The LLM may infer risk by linking consequences with the causes identified in the interaction data (e.g., using pattern analysis or causal logic). In some examples, the LLM may associate the tone of the interaction data with risk (e.g., negative sentiment, cautious tone, uncertainty in modal verbs, warning signals of concern, etc.)

Anomalies 1850 may include determining parts of the interaction data that may not correspond to the previously detected patterns, tone, etc. in the interaction data. The anomalies may be unusual, unexpected, or inconsistent communications in comparison to the rest of the interaction data (e.g., “The patient's minimal responses deviate from the expected level of engagement and communication in a post-operative care scenario.”).

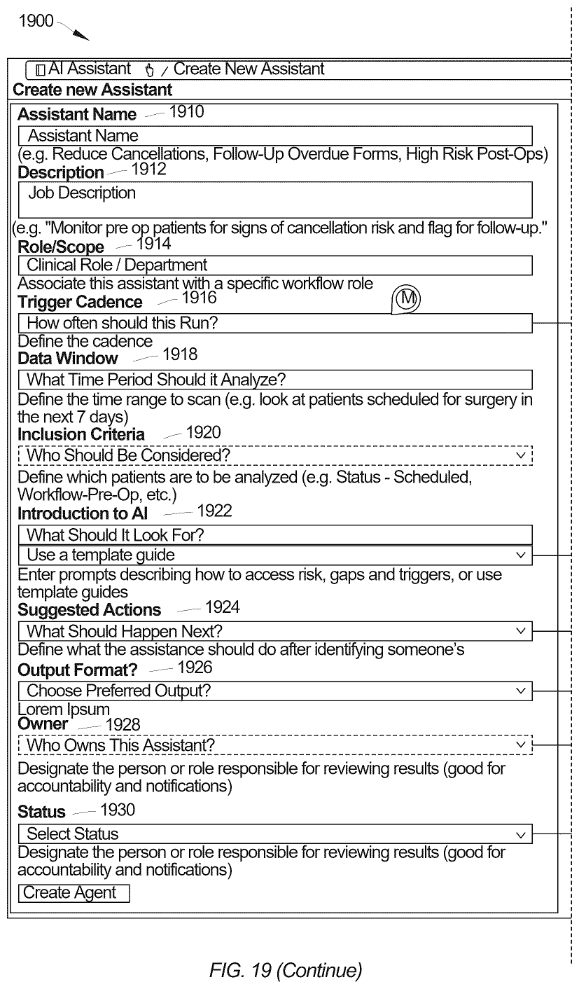

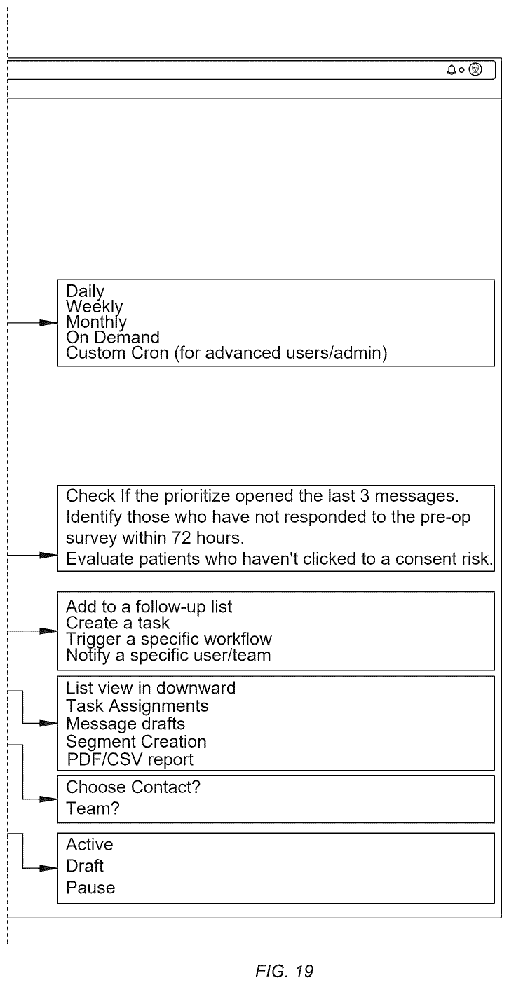

Turning to FIG. 19, an interface 1900 providing a tool to generate a new assistant that interacts with the interaction data in response to a prompt is depicted. For example, the provider can create the assistant tool by defining rules that can be repeated over multiple prompts or iterations absent providing the prompt each time. The rules may define various aspects of the prompt/answer process, including a specific subset of interaction data (e.g., forms, surveys, message history, etc.), segments that the patient is associated with, or a workflow to initiate with each new interaction (e.g., create a report, update an interaction log, etc.).

In this example, the assistant tool with corresponding rules can include a name 1910, description of the assistant tool 1912, groups 1914 associated to the clinical role or provider department, trigger condition 1916 (e.g., daily, weekly, monthly, on demand, or custom), data window 1918 (e.g., timing to activate the assistant tool), inclusion offset 1920 (e.g., “what should be considered”), interesting information 1922 (e.g., “what should I look for?”), suggested action 1924 (e.g., “what should happen next?”), output format 1926, owner 1928, and status 1930.

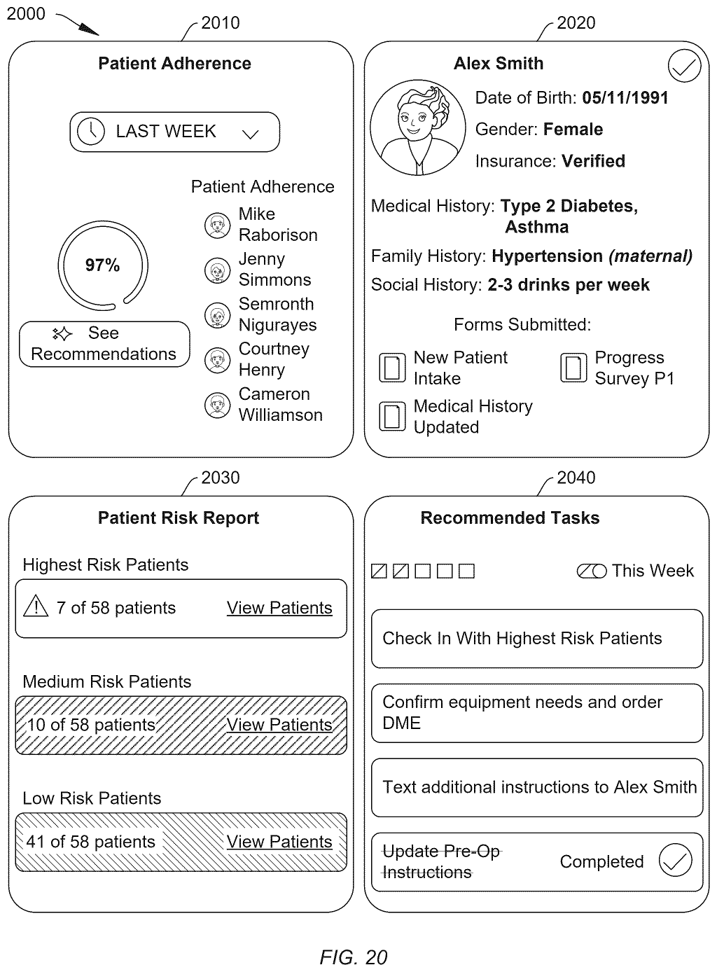

Turning to FIG. 20, an interface 2000 providing examples of summaries of the interaction data is depicted. In this example, the summaries may include interaction data that is aggregated at a clinic level, including a set of patients and providers that are associated with the single location. Using this aggregated interaction data, the provider can identify the overall patient adherence to communications 2010, patient risk 2030, and recommended tasks 2040. In some example, the interface 2000 can also show an individual patient 2020 that may be associated with a higher risk score or other information.

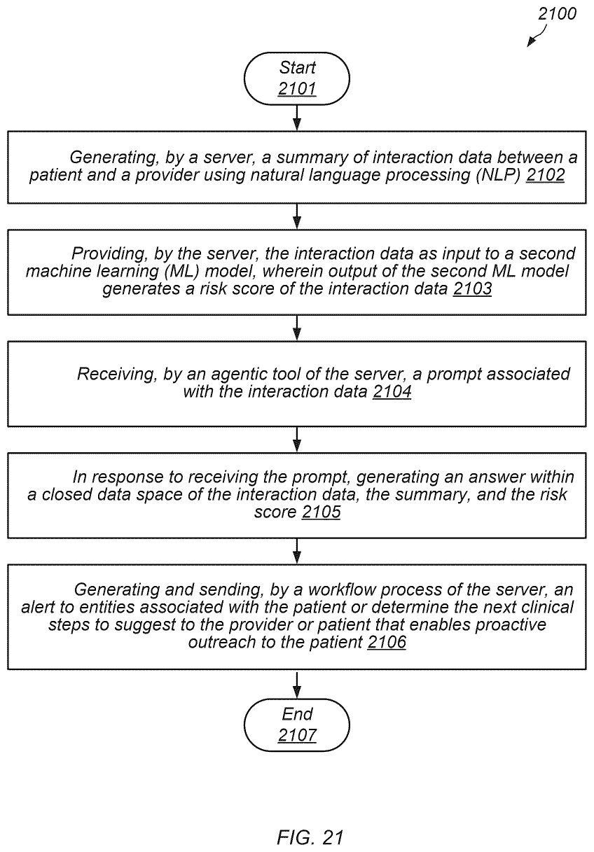

Turning to FIG. 21, a flow diagram 2100 depicting an embodiment of a method for operating a server included in a content management and delivery system is depicted. The method, which may be applied to various servers, e.g., server 101 as depicted in FIG. 1, begins in block 2101.

The method includes generating a summary of interaction data between a patient and a provider using a large language model (LLM) (block 2102). The LLM may use natural language processing (NLP) techniques to process the interaction data into the summary of interaction data.

The method further includes providing the interaction data as input to a second machine-learning (ML) model (block 2103). The output of the second ML model can comprise a generated risk score of the interaction data. The risk score, for example, can be associated with the risk of good or poor care, gaps in care or communications, or other inferences/relationships in the interaction data that may not align with the intended treatment of the patient.

In some embodiments, the second ML model may be a model corresponding to logistic regression (e.g., the probability of a binary outcome), tree-based ensembles (e.g., Random Forest, Gradient Boosting Machines like XGBoost and LightGBM, or Extra Trees), or a neural network that has learned to identify textual indicators of risk in the interaction data based on how risks are described in the training data. The indicators may be converted to a number or other scoring format. The risk score may be compared with a threshold value to identify a high risk score or low risk score and corresponding actions to each.

The method further includes receiving, by an agentic tool, a prompt associated with the interaction data (block 2104). The agentic tool can use NLP techniques and other AI methods to receive and understand prompts/instructions, interact with applications or APIs and the server/data, monitor the agentic tool's own progress, and self-correct as needed. For example, using the agentic tool, the provider can submit a prompt related to the history of communications between the patient and provider, access to documents within the system, and the like.

The method further includes generating an answer within a closed data space of the interaction data, the summary, and the risk score in response to receiving the prompt (block 2105). The agentic tool may process the prompt from the provider and generate a response that restricts access to additional data other than the interaction data. The agentic tool can synthesize the data and generate the answer in response to answer the prompt.

The method further includes generating and sending, by a workflow process, an alert to one or more entities associated with the patient or determine at least one next clinical step to suggest to the provider or patient that enables proactive outreach to the patient (block 2106). The alert may comprise the next clinical step within the data portion of the alert. For example, the alert may comprise information from the interaction data, including short message service (SMS) or email messages, analytics data, clicks, content views, receiving a completed form, two-way conversational history (e.g., via phone, text, form, chat, etc.), patient inaction (e.g., the provider sending a message but the patient not opening the message from the provider, lack of transportation to a medical appointment, or medication confusion), and the like.

In some embodiments, the workflow process may include a series of clinical steps associated with an attribute of the patient (e.g., not having a car leads to a predicted inability to attend an in-person appointment next week). The workflow process may identify suggested actions for the provider or patient to initiate to encourage an adjustment to the predicted action/attribute of the user. In some embodiments, the clinical steps in the workflow process may be determined prior to the generation of the summary of the interaction data.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

“A”, “an”, and “the,” as used herein, refers to both singular and plural referents unless the context clearly dictates otherwise. By way of example, “a processor” programmed to perform various functions refers to one processor programmed to perform each and every function, or more than one processor collectively programmed to perform each of the various functions.

Numerous variations and modifications will become apparent to those skilled in the art once the above disclosure is fully appreciated. It is intended that the following claims be interpreted to embrace all such variations and modifications.

What is claimed is:

1. A method comprising:
generating, by a server, a summary of interaction data between a patient and a provider using a large language model (LLM), wherein the LLM uses natural language processing (NLP) techniques to process the interaction data into the summary of interaction data;
providing, by the server, the interaction data as input to a second machine-learning (ML) model, wherein output of the second ML model generates a risk score of the interaction data;
receiving, by an agentic tool of the server, a prompt associated with the interaction data;
in response to receiving the prompt, generating an answer within a closed data space of the interaction data, the summary, and the risk score; and
generating and sending, by a workflow process of the server, an alert to one or more entities associated with the patient or determine at least one next clinical step to suggest to the provider or patient that enables proactive outreach to the patient.

2. The method of claim 1 wherein the risk score is generated using a dictionary of risk terms.

3. The method of claim 1 further comprising:
generating, using the LLM, a sentiment, insight, risk, or anomaly of the interaction data; and
providing the summary of the interaction data, sentiment, insight, risk, or anomaly to an interface.

4. The method of claim 1, wherein the second ML model is logistic regression, tree-based ensembles, or a neural network.

5. The method of claim 1, wherein the risk score is associated with risk of quality of care, gaps in care or communications, or other inferences in the interaction data.

6. The method of claim 1 further comprising, in response to determining that the risk score exceeds a threshold value, generating the alert associated with the patient.

7. The method of claim 1 further comprising, in response to determining that the risk score exceeds a threshold value, determining that the at least one next clinical step comprises the proactive outreach or care coordination.

8. The method of claim 1, wherein the alert comprises a Short Message Service (SMS) message.

9. A non-transitory computer-accessible storage medium having program instructions stored therein that, in response to execution by a computer system, causes the computer system to perform operations comprising:
generating a summary of interaction data between a patient and a provider using a large language model (LLM), wherein the LLM uses natural language processing (NLP) techniques to process the interaction data into the summary of interaction data;
providing the interaction data as input to a second machine-learning (ML) model, wherein output of the second ML model generates a risk score of the interaction data;
receiving, by an agentic tool, a prompt associated with the interaction data;
in response to receiving the prompt, generating an answer within a closed data space of the interaction data, the summary, and the risk score; and
generating and sending, by a workflow process, an alert to one or more entities associated with the patient or determine at least one next clinical step to suggest to the provider or patient that enables proactive outreach to the patient.

10. The non-transitory computer-accessible storage medium of claim 9, wherein the risk score is generated using a dictionary of risk terms.

11. The non-transitory computer-accessible storage medium of claim 9, wherein the operations further comprise:
generating, using the LLM, a sentiment, insight, risk, or anomaly of the interaction data; and
providing the summary of the interaction data, sentiment, insight, risk, or anomaly to an interface.

12. The non-transitory computer-accessible storage medium of claim 9, wherein the second ML model is logistic regression, tree-based ensembles, or a neural network.

13. The non-transitory computer-accessible storage medium of claim 9, wherein the risk score is associated with risk of quality of care, gaps in care or communications, or other inferences in the interaction data.

14. The non-transitory computer-accessible storage medium of claim 9, wherein the operations further comprise, in response to determining that the risk score exceeds a threshold value, generating the alert associated with the patient.

15. The non-transitory computer-accessible storage medium of claim 9, wherein the operations further comprise, in response to determining that the risk score exceeds a threshold value, determining that the at least one next clinical step comprises the proactive outreach or care coordination.

16. A system comprising:
one or more memory circuits configured to store instructions; and
one or more processors configured to receive instructions from the one or more memory circuits and execute the instructions to cause the system to perform operations comprising:
generating a summary of interaction data between a patient and a provider using a large language model (LLM), wherein the LLM uses natural language processing (NLP) techniques to process the interaction data into the summary of interaction data;
providing the interaction data as input to a second machine-learning (ML) model, wherein output of the second ML model generates a risk score of the interaction data;
receiving, by an agentic tool, a prompt associated with the interaction data;
in response to receiving the prompt, generating an answer within a closed data space of the interaction data, the summary, and the risk score; and
generating and sending, by a workflow process, an alert to one or more entities associated with the patient or determine at least one next clinical step to suggest to the provider or patient that enables proactive outreach to the patient.

17. The system of claim 16, wherein the risk score is generated using a dictionary of risk terms.

18. The system of claim 16, further comprising:
generating, using the LLM, a sentiment, insight, risk, or anomaly of the interaction data; and
providing the summary of the interaction data, sentiment, insight, risk, or anomaly to an interface.

19. The system of claim 16, wherein the second ML model is logistic regression, tree-based ensembles, or a neural network.

20. The system of claim 16, wherein the risk score is associated with risk of quality of care, gaps in care or communications, or other inferences in the interaction data.
